(19) United States
(12) Patent Application Publication
(10) Pub. No.: US 2026/0039689 A1
(43) Pub. Date: Feb. 5, 2026

(54) AUTOMATED DETECTION AND MITIGATION OF BOT ATTACKS USING MACHINE LEARNING

(71) Applicant: Cequence Security, Inc., Sunnyvale, CA (US)

(72) Inventors: Devang Agrawal, Sunnyvale, CA (US); Khyati Ganatra, San Jose, CA (US); William Glazier, San Francisco, CA (US)

(21) Appl. No.: 19/285,353

(22) Filed: Jul. 30, 2025

Related U.S. Application Data
(60) Provisional application No. 63/677,478, filed on Jul. 31, 2024.

(51) Int. Cl. H04L 9/40; H04L 41/16

(52) U.S. Cl. CPC H04L 63/1466; H04L 41/16; H04L 63/1425; H04L 63/20

(57) ABSTRACT

Various embodiments include a system that utilizes machine learning to detect and mitigate bot attacks. The system comprises processing circuitry. The processing circuitry obtains historical traffic data and attack traffic data in response to an attack notification. The attack traffic data characterizes traffic received during a bot attack and the historical traffic data characterizes other traffic received when the bot attack is not occurring. The processing circuitry extracts features from the historical traffic data and the attack traffic data. The processing circuitry trains a machine learning classifier to identify the features that correspond to attack traffic and the features that correspond to legitimate traffic. The processing circuitry forms decision rules based on an output from the machine learning classifier to block the attack traffic based on the features that correspond to the attack traffic. The processing circuitry generates one or more security policies based on the decision rules.

### CROSS-REFERENCE TO RELATED APPLICATIONS

This U.S. patent application claims the benefit of and priority to U.S. Provisional Patent Application 63/677,478 titled, “AUTOMATED DETECTION AND MITIGATION OF BOT ATTACKS USING MACHINE LEARNING” which was filed on Jul. 31, 2024, and which is hereby incorporated by reference into this U.S. patent application in its entirety.

### TECHNICAL FIELD

Various embodiments of the present technology relate to web security, and more specifically, to utilizing machine learning techniques to detect and mitigate bot attacks.

### BACKGROUND

The security of a web service is of upmost importance to both the operators of the website and its users. As Internet communications expand for business transactions and other services, more threats to website security arise. Website owners, insurers, hosting services, and others involved in the provision of a web service typically strive to create a robust security infrastructure for a website to prevent nefarious individuals from compromising the site. However, despite these security precautions, a website could still be subject to intrusions by computer hackers, malware, viruses, and other malicious attacks. Websites may be vulnerable to security breaches for a variety of reasons, including security loopholes, direct attacks by malicious individuals or software applications, dependencies on compromised third-party providers, and other security threats. Security systems are employed by websites to counteract the wide range of threats.

Many web applications utilize Application Programming Interfaces (APIs) based applications for functions like sales productivity, collaboration, marketing automation, and project tracking. API usage has increased as organizations have expanded their use of microservices and created new cloud-native applications. The consumer facing applications that the organizations create are often API based. This API ecosystem is fueled by increases in public cloud environments, Kubernetes environments, serverless environments, and use of third-party Software As A Service (SaaS) systems. Developers may roll out new API driven services in any environment. Critical information like personal information, financial information, health information, and the like is stored behind the applications that host these APIs. Malicious actors often utilize APIs as entry points to perform unwanted actions (e.g., obtaining sensitive data). It is difficult for security systems to counter malicious actors given the large and increasing number of APIs.

Machine learning models are designed to recognize patterns, produce recommendations, and automatically improve through training and the use of data. Examples of machine learning models include foundational models, Large Language Models (LLMs), artificial neural networks, nearest neighbor methods, gradient-boosted trees, ensemble random forests, support vector machines, naïve Bayes methods, and linear regressions. Machine learning models are trained using training data sets. During the training process, the models process the training data and produce training outputs. The models compare the training outputs to expected outputs and adjust their constituent machine learning algorithms to achieve desired output accuracy. Once trained, the models may ingest live data and process the live data using their trained algorithms to produce recommendations, predictions, and the like. Unfortunately, conventional API or other web application security systems do not effectively or efficiently utilize machine learning to detect and mitigate bot attacks and thus do not provide comprehensive protection mechanisms against threat and bot attacks that evolve rapidly.

### Overview

This Overview is provided to introduce a selection of concepts in a simplified form that are further described below in the Technical Description. This summary is not intended to identify key features or essential features of the claimed subject matter, nor is it intended to be used as an aid in determining the scope of the claimed subject matter.

Various embodiments of the present technology relate to solutions for bot attack detection and mitigation. Some embodiments comprise a method. The method comprises, in response to an attack notification, obtaining historical traffic data and attack traffic data. The attack traffic data characterizes traffic received during a bot attack and the historical traffic data characterizes other traffic received when the bot attack is not occurring. The method further comprises extracting features from historical traffic data and the attack traffic data. The method further comprises training a machine learning classifier to identify the features that correspond to attack traffic and the features that correspond to legitimate traffic. The method further comprises forming decision rules based on an output from the machine learning classifier to block the attack traffic based on the features that correspond to the attack traffic. The method further comprises generating one or more security policies based on the decision rules.

Some embodiments comprise a system. The system comprises processing circuitry. In response to an attack notification, the processing circuitry obtains historical traffic data and attack traffic data. The attack traffic data characterizes traffic received during a bot attack and the historical traffic data characterizes other traffic received when the bot attack is not occurring. The processing circuitry extracts features from the historical traffic data and the attack traffic data. The processing circuitry trains a machine learning classifier to identify the features that correspond to attack traffic and the features that correspond to legitimate traffic. The processing circuitry forms decision rules based on an output from the machine learning classifier to block the attack traffic based on the features that correspond to the attack traffic. The processing circuitry generates one or more security policies based on the decision rules.

Some embodiments comprise one or more non-transitory computer readable storage media that store program instructions. When executed by a computing system, the program instructions direct the computing system to perform operations. The operations comprise, in response to an attack notification, obtaining historical traffic data and attack traffic data. The attack traffic data characterizes traffic received during a bot attack and the historical traffic data characterizes other traffic received when the bot attack is not occurring. The operations further comprise extracting features from the historical traffic data and the attack traffic data. The operations further comprise training a machine learning classifier to identify the features that correspond to attack traffic and the features that correspond to legitimate traffic. The operations further comprise forming decision rules based on an output from the machine learning classifier to block the attack traffic based on the features that correspond to the attack traffic. The operations further comprise generating one or more security policies based on the decision rules.

### DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an example of a system that utilizes machine learning for automatic bot attack detection and mitigation.

FIG. 2 illustrates an example operation of the system to utilize machine learning for automatic bot attack detection and mitigation.

FIG. 3 illustrates an example of a communication network that utilizes machine learning for automatic bot attack detection and mitigation.

FIG. 4 illustrates an example operation of the communication network to utilize machine learning for automatic bot attack detection and mitigation.

FIG. 5 illustrates an example of a machine learning bot detection system that utilizes machine learning for automatic bot attack detection and mitigation.

FIG. 6 illustrates an example of a computing system for machine learning based automatic bot attack detection and mitigation.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### TECHNICAL DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

Organizations today face an escalating threat from sophisticated bot attacks that compromise the security and integrity of their online services. Attackers employ advanced tactics such as browser fingerprint spoofing and Internet Protocol (IP) rotation. Specifically, advanced attackers are able to blend seamlessly with legitimate traffic as they are able to reverse engineer fingerprints. Traditional methods of bot mitigation, which rely heavily on manual analysis and the creation of IP-based policies or static signature-based policies, fall short in addressing these challenges.

To address these deficiencies of conventional bot detection systems, various embodiments of the present technology include a machine learning based security system to automatically detect and mitigate sophisticated bot attacks. The machine learning system comprises algorithms that are trained in response to the detection of a bot attack to identify features specific to the detected attack. By training the algorithms on-the-fly, the machine learning system generates security policies tailored for specific attacks. The robust nature of the security policies inhibits malicious actors from bypassing in-place security policy protections, even when they change tactics of the bot attack. The machine learning system implements an end-to-end process of identifying malicious actors by automatically identifying specific attack features. The machine learning system analyzes requests/responses (e.g., a Hypertext Transfer Protocol (HTTP) request) to find elements in the request that are characteristic of attack traffic but not present in legitimate traffic. Additionally, the system is responsible for automatically generating mitigation policies based on these identified features. This involves not only detecting the unique signatures of attack traffic but also translating these detections into actionable policies to effectively block such bot attacks. Traffic on a good/mixed fingerprint or endpoint, during normal times without attacks, exhibits a distribution in features like request headers, cookies, query parameters and many more remain fairly consistent over time. However, when an attack begins, it becomes extremely difficult and unlikely for an attacker to replicate this consistent distribution across all features. The machine learning system leverages this fact to identify features where the distribution deviates from the legitimate one. Advantageously, the machine learning system effectively and efficiently filters out the attack traffic. Now referring to the Figures.

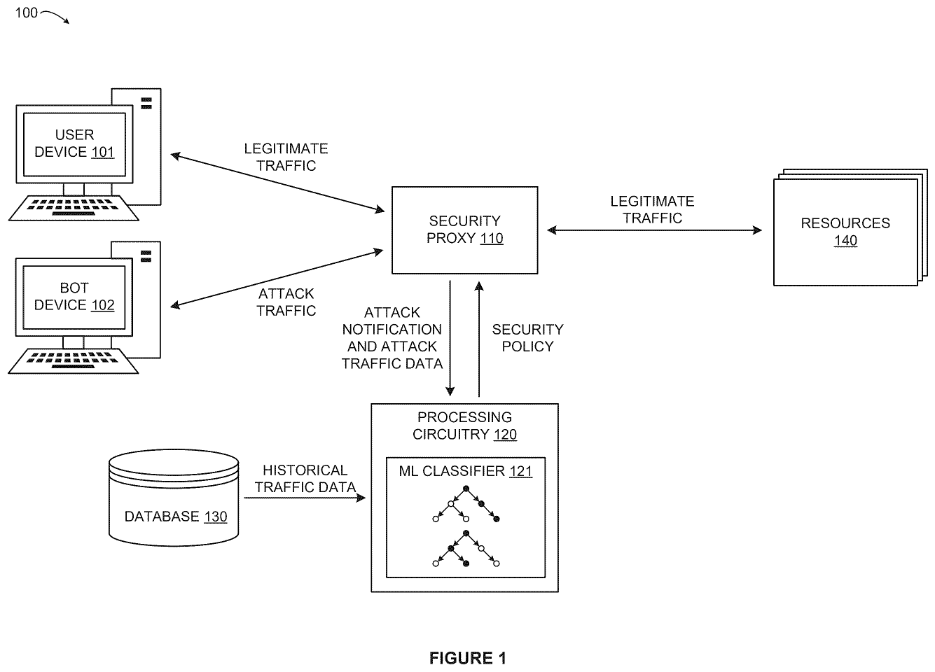

FIG. 1 illustrates system 100 that utilizes machine learning to detect and mitigate bot attacks. System 100 provides services like online networking, content distribution, web application services, web application security, machine learning, and the like. System 100 comprises user device 101, bot device 102, security proxy 110, processing circuitry 120, database 130, and resources 140. Processing circuitry 120 comprises machine learning (ML) classifier 121. In other examples, system 100 may comprise additional or different elements than those illustrated in FIG. 1. Likewise, the illustrated components of system 100 may include fewer or additional components, assets, or connections than shown. User device 101, security proxy 110, processing circuitry 120, and LLM 130 may be representative of a single computing apparatus or multiple computing apparatuses.

Various examples of system operation and configuration are described herein. In some examples, user device 101 exchanges legitimate traffic (e.g., API calls, HTTP requests, etc.) with resources 140. The legitimate traffic is routed through security proxy 110. Security proxy 110 applies security policies to the legitimate traffic to screen for malicious, unauthorizes, or otherwise unwanted requests. Security proxy 110 may report data that characterizes the legitimate traffic to database 130. Database 130 may store the received data as historical traffic data. The historical traffic data may characterize request headers, request cookies, request body keys, query parameters, alphabetical characters, digits, special characters, and/or other information included in the historic traffic data.

Bot device 102 initiates a bot attack to target resources 140. The bot attack may attempt to access unauthorized resources, drive resources 140 to expose sensitive user information, engage in criminal activity, and/or perform some other unwanted operation. Bot device 102 transfers attack traffic (e.g., malformed API calls, unauthorized HTTP requests, etc.) towards resources 140. Security proxy 110 intercepts the attack traffic and determines that a bot attack has begun. For example, security proxy 110 may detect an increase in the total request volume, an increase in blocked requests, an increase in requests from a specific Internet Protocol (IP) address and the like to detect the bot attack. Security proxy 110 generates attack traffic data that characterizes the attack. The attack traffic data may characterize request headers, request cookies, request body keys, query parameters, alphabetical characters, digits, special characters, and/or other information included in the attack traffic data. Security proxy 110 transfers an attack notification to processing circuitry 120.

Processing circuitry 120 receives the attack notification and in response, obtains the attack traffic data from security proxy 110 and the historic traffic data from database 130. Processing circuitry 120 extracts features from the historic traffic data and the attack traffic data. The extracted features characterize the request headers, request cookies, request body keys, query parameters, alphabetical characters, digits, special characters, and/or other information included in the historical and attack traffic data. For example, processing circuitry 120 may generate feature vectors (i.e., numeric representations of data interpretable by machine learning models) that represent the request headers of the legitimate traffic and the attack traffic. Processing circuitry 120 provides the features to machine learning classifier 121. Machine learning classifier 121 trains its constituent algorithms to identify features that correspond to the attack traffic and to identify the features that correspond to the legitimate traffic. For example, machine learning classifier 121 may generate a decision tree that identifies which features are unique to the attack traffic. Processing circuitry 120 forms decision rules based on the output from machine learning classifier 121. The decision rules are used to block the attack traffic based on the features identified by machine learning classifier that correspond to the attack traffic. Processing circuitry 120 generates one or more security policies based on the decision rules and provides the security policies to security proxy 110. Security proxy 110 applies the security policies to block the attack traffic from reaching resources 140.

Advantageously, system 100 effectively and efficiently utilizes machine learning to detect and mitigate bot attacks. Moreover, system 100 provides comprehensive protection mechanisms against threat and bot attacks that evolve rapidly.

Machine learning classifier 121 is representative of one or more machine learning models trained to classify features unique to attack traffic, form decision rules based on the classified features, and generate security polices based on the decision rules to block the attack traffic. A machine learning model comprises one or more machine learning algorithms that are trained to produce outputs based on historical data and/or other types of training data. A machine learning model may employ one or more machine learning algorithms through which data can be analyzed to identify patterns, make decisions, make predictions, or similarly produce output. Machine learning classifier may comprise random forest classifiers, Three Dimensional (3D) deep leaning models, 3D convolutional neural networks, Large Language Models (LLMs), times series convolutional deep learning, transformers, multi-layer perceptron, long term short memory, attention based deep learning model, artificial neural networks, nearest neighbor methods, ensemble random forests, support vector machines, naïve Bayes methods, linear regressions, or similar machine learning techniques or combinations thereof capable of predicting output based on input data.

While user device 101 and bot device 102 are illustrated as comprising a personal computer, user device 101 and bot device 102 may comprise another device with data communication circuitry like a smartphone, a server computer, a sensor, a drone, a vehicle, and the like. User device 101, bot device 102, security proxy 110, processing circuitry 120, and database 130, and resources 140 communicate over communication systems like routers, gateways, telecommunication switches, servers, processing systems, or other communication equipment and systems for providing communication and data services. The communication systems could comprise wireless communication nodes, telephony switches, Internet routers, network gateways, computer systems, communication links, or some other type of communication equipment, including combinations thereof. The communication systems may also comprise optical networks, packet networks, local area networks (LAN), metropolitan area networks (MAN), wide area networks (WAN), or other network topologies, equipment, or systems, including combinations thereof.

User device 101, bot device 102, security proxy 110, processing circuitry 120, and database 130, and resources 140 may communicate over wired or wireless communication links. The communication links that connect the elements of system 100 use metallic links, glass fibers, radio channels, or some other communication media. The communication links may use Internet Protocol (IP), Time Division Multiplex (TDM), Data Over Cable System Interface Specification (DOCSIS), IP, General Packet Radio Service Transfer Protocol (GTP), Institute of Electrical and Electron Engineers (IEEE) 802.11 (Wifi), IEEE 802.3 (Ethernet), optical networking, wireless protocols, communication signaling, virtual switching, inter-processor communication, bus interfaces, or some other communication format, including combinations thereof.

User device 101, bot device 102, security proxy 110, processing circuitry 120, and database 130, and resources 140 comprise microprocessors, software, memories, transceivers, bus circuitry, and the like. The microprocessors comprise Central Processing Units (CPU), Graphical Processing Units (GPU), Application-Specific Integrated Circuits (ASIC), Field Programmable Gate Array (FPGA), and/or types of processing circuitry. The memories comprise Random Access Memory (RAM), Solid State Drives (SSDs), Hard Disk Drives (HDDs), Non-Volatile Memory Express (NVMe) SSDs, and/or the like. The memories store software like operating systems, security modules, machine learning models, user applications, web applications, and browser applications. The microprocessors retrieve the software from the memories and execute the software to drive the operation of system 100 as described herein.

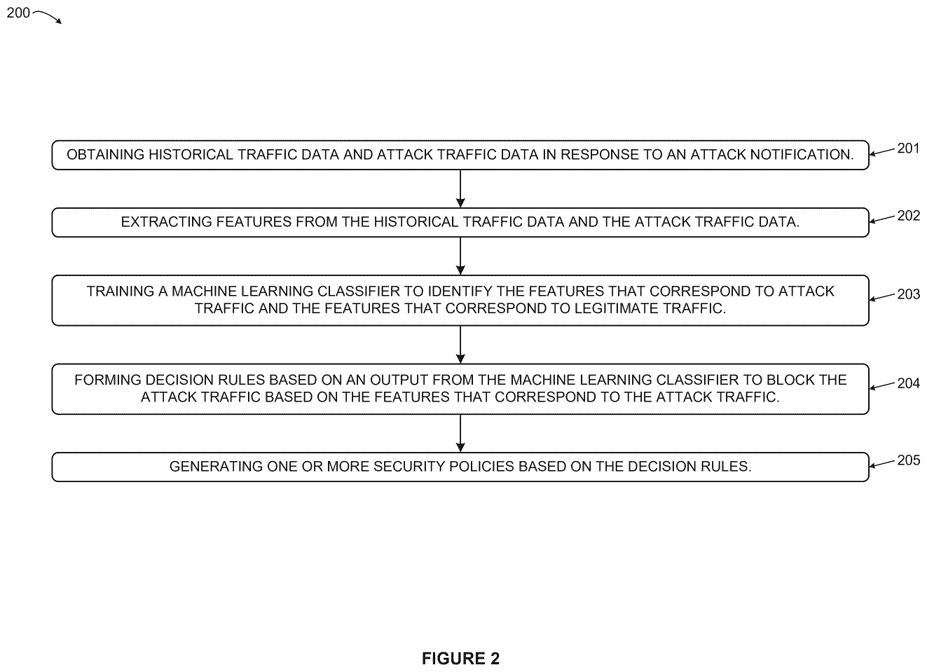

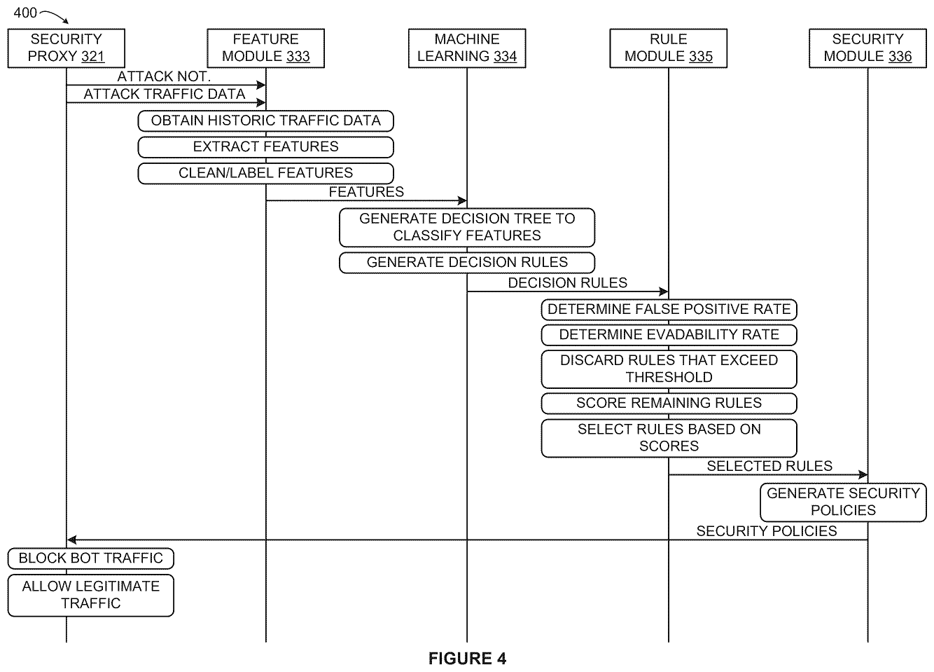

In some examples, system 100 implements process 200 illustrated in FIG. 2 and/or process 400 illustrated in FIG. 4. It should be appreciated that the structure and operation of system 100 may differ in other examples.

FIG. 2 illustrates process 200. Process 200 comprises an example operation of system 100 to utilize machine learning to detect and mitigate bot attacks. Process 200 comprises an example of process 400 illustrated in FIG. 4, however process 400 may differ. Process 200 may vary in other examples. In some examples, the operations of process 200 comprise obtaining historical traffic data and attack traffic data in response to an attack notification (step 201). The attack traffic data characterizes requests received during a bot attack and the historical traffic data characterizes historical requests received during normal operating conditions. The operations further comprise extracting features from the historical traffic data and the attack traffic data (step 202). The operations further comprise training a machine learning classifier to identify the features that correspond to attack traffic and the features that correspond to legitimate traffic (step 203). The operations further comprise forming decision rules based on an output from the machine learning classifier to block the attack traffic based on the features that correspond to the attack traffic (step 204). The operations further comprise generating one or more security policies based on the decision rules (step 205).

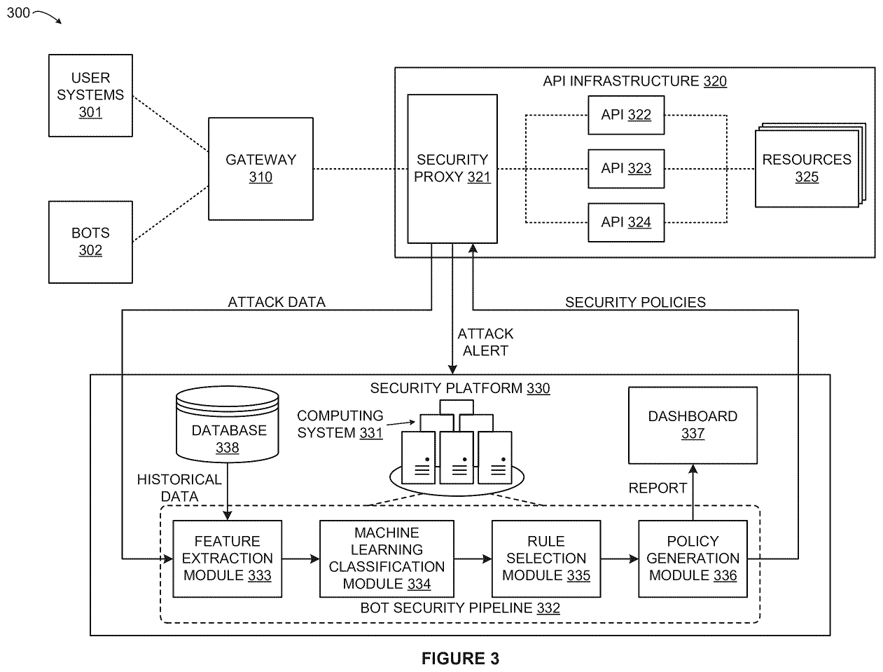

FIG. 3 illustrates communication network 300 that utilizes machine learning techniques to detect and mitigate bot attacks. Communication network 300 comprises an example of system 100 illustrated in FIG. 1, however system 100 may differ. Communication network 300 comprises user systems 301, bots 302, gateway 310, API infrastructure 320, and security platform 330. API infrastructure 320 comprises security proxy 321, Application Programming Interfaces (APIs) 322-324, and resources 325. Security platform 330 comprises computing system 331, bot security pipeline 332, dashboard 337, and database 338. Bot security pipeline 332 comprises feature extraction module 333, machine learning classification module 334, rule selection module 335, and policy generation module 336. In other examples, communication network 300 may comprise additional or different elements than those illustrated in FIG. 1. Likewise, the illustrated components of communication network 300 may include fewer or additional components, assets, or connections than shown. User systems 301, gateway 310, API infrastructure 320, and security platform 330 may be representative of a single computing apparatus or multiple computing apparatuses.

In some examples, user systems 301 and bots 302 are computing systems that generate and transfer HTTP requests, API calls, or other types of traffic over gateway 310 and security proxy 321 for resources 325. User systems 301 comprise examples of user device 101 illustrated in FIG. 1, however user device 101 may differ. Bots 302 comprise an example of bot device 102 illustrated in FIG. 1, however bot device 102 may differ. The API calls, HTTP requests, or other traffic may comprise requests to access web resources, content retrieval requests, machine learning inputs like LLM queries, banking/monetary inputs, or other types of requests. The traffic to API infrastructure 320 from user systems 301 and bots 302 is comingled, however the traffic sent by bots 302 may be malicious. For example, a malicious actor may utilize bots 302 to launch an attack against API infrastructure 320. Exemplary bot attacks may attempt to disrupt a site (e.g., through high request volume), steal data, make fraudulent purchases, and the like. Bots 302 may utilize tactics like browser fingerprint spoofing and IP rotation to perform bot attacks against API infrastructure 320. Examples of user systems 301 and bots include mobile computing devices, such as cell phones, tablet computers, laptop computers, notebook computers, and gaming devices, as well as any other type of mobile computing devices and any combination or variation thereof. Examples of user systems 301 and bots also include smartphones, desktop computers, server computers, virtual machines, sensors, drones, vehicles, as well as any other type of computing system, variation, or combination thereof. User stems 301 may be representative of human controlled systems (e.g., a smartphone) while bots 302 may be representative of automated systems.

Gateway 310 is a computing system that routes the API calls, HTTP requests, and other traffic intended for resources 325 to ones of APIs 322-324 in API infrastructure 320. Examples of gateway 310 include Content Deliver Network (CDN) gateways, API gateways, default gateways, media gateways, payment gateways, Voice Over Internet Protocol (VOIP) gateways, residential gateways, enterprise gateways, cloud gateways, IoT gateways, as well as any other type of gateway computing devices and any combination or variation thereof. Examples of gateway 310 also include desktop computers, server computers, and virtual machines, as well as any other type of computing system, variation, or combination thereof.

API infrastructure 320 is representative of an enterprise computing environment. Examples of API infrastructure 320 may include server computers and data storage devices deployed on-premises, in the cloud, in a hybrid cloud, or elsewhere, by service providers such as enterprises, organizations, individuals, and the like. API infrastructure 320 may rely on the physical connections provided by one or more other network providers such as transit network providers, Internet backbone providers, and the like to communicate with and provide services to external systems. In some examples, the computing systems of API infrastructure 320 could comprise a web server, CDN, forward/reverse proxy, load balancer, middleware, cloud server, network switch, router, switching system, packet gateway, network gateway system, Internet access node, application server, database system, service node, firewall, or some other communication system, including combinations thereof.

APIs 322-324 are representative of a set of API servers, computing systems, and/or network equipment configured to provide services and web resources to clients and/or operators of API infrastructure 320. In particular, APIs 322-324 route API calls, HTTP requests, or other traffic received over security proxy 321 to resources 325. APIs 322-324 may comprise client-side APIs and server-side APIs. APIs 322-324 may be representative of any computing apparatus, system, or systems that may connect to another computing system over a communication network. Some examples of computing systems that host APIs 322-324 include database systems, server computers, cloud computing platforms, and virtual machines, as well as any other type of computing system, variation, or combination thereof. The API servers may be in various environments like the cloud, Kubernetes, serverless, data center, and the like.

Security proxy 321 is representative of servers, computing systems, and/or network equipment to enforce security policies on API calls, HTTP requests, or other traffic received and transferred by API infrastructure 320. The security policies block malicious or otherwise unwanted API calls from reaching APIs 322-324. Security proxy 321 generates and transfers data that characterizes the API calls/responses, HTTP requests, or other traffic to security platform 330. Some examples of computing systems that host security proxy 321 include database systems, server computers, cloud computing platforms, and virtual machines, as well as any other type of computing system, variation, or combination thereof.

Resources 325 are representative of servers, computing systems, and/or network equipment to store content and provide services in response to requests received from APIs 322-324. Resources 325 may comprise user data servers, content delivery nodes, application servers, online gaming servers, databases, data lakes, machine learning model repositories, and the like. Some examples of computing systems that host resources 325 include database systems, server computers, cloud computing platforms, and virtual machines, as well as any other type of computing system, variation, or combination thereof.

Security platform 330 is representative of a web security platform that utilizes machine learning techniques to generate security policies to block malicious bot traffic in response a bot attack detected by security proxy 321. When notified of a bot attack, security platform 330 obtains traffic sent over gateway 310 for APIs 322-324 and obtains historical traffic logs (e.g., stored in database 338) of traffic sent over gateway 310 when a bot attack is not occurring. Platform 330 inputs the obtained traffic into bot security pipeline 332 to train a machine learning model to differentiate legitimate traffic from the bot traffic and derive security policies to block the bot traffic while allowing the legitimate traffic.

Computing system 331 in security platform 330 may comprise servers, cloud computing systems, or any other computing system, network equipment, apparatus, system, or systems that may connect to another computing system over a communication network. Computing system 331 comprises an example of processing circuitry 120 illustrated in FIG. 1, however processing circuitry 120 may differ. Some examples of computing system 331 include database systems, desktop computers, server computers, cloud computing platforms, and virtual machines, as well as any other type of computing system, variation, or combination thereof. In some examples, computing system 331 comprises a distributed streaming platform to maintain transactions logs of events (e.g., API calls/responses, HTTP requests, attack notifications, etc.) in API infrastructure 320. The transactions logs typically comprise time-ordered events. The transaction logs record the transactions of APIs 322-324 redundantly to increase the immutability and scalability of the streaming platform. Exemplary distributed streaming platform types include Apache Kafka, Apache Flink, and Apache Spark.

Bot security pipeline 332 is implemented by computing system 331 and is representative of one or more machine learning models or other applications to generate security policies to block malicious, unauthorized, or unwanted bot traffic in response to bot attacks detected by security proxy 321. Bot security pipeline 332 comprises an example of machine learning classifier 121 illustrated in FIG. 1, however machine learning classifier 121 may differ.

Feature extraction module 333 processes attack traffic data and historical traffic data to identify features that distinguish the traffic. These features include unique values or patterns in request headers, request cookies, request body, query parameters, and the like that are characteristic of attack traffic (e.g., traffic transferred by bots 302) but not present in legitimate traffic (e.g., traffic transferred by user systems 301). Once extracted, feature extraction module 333 cleans the data to remove outliers and null values. Machine learning classification module 334 comprises a decision tree-based machine learning algorithm trained on the extracted features to classify requests as either “good” or “bad” based on the extracted features. The maximum tree depth is restricted to facilitate simpler and more interpretable decision trees and to prevent overfitting. By preventing overfitting, machine learning classification module 334 reduces the computing resources (e.g., processor load, memory percent occupancy, power consumption, etc.) needed to classify the features. This improves the overall function of computing system 331.

Machine learning classification module 334 traversing all decision paths in the trained decision tree to determine ‘bad’ decision rule classifications for the extracted features. Machine learning classification module 334 may compute recall for each rule. It should be appreciated that a single decision tree provides a limited set of rules. As such, machine learning classification module 334 comprises capabilities to expand the spectrum of detectable patterns to enrich the output for analysis and capture subtle feature interactions that indicate sophisticated bot attacks. Machine learning classification module 334 determines all possible one-feature rules are generated based on the equality or inequality of a feature value and computes metrics for each rule by implementing a vectorized solution. It should be appreciated that computing the metrics for all possible multi-feature combinations is computationally intensive. As such, machine learning classification module 334 trains a random forest classifier without bootstrap aggregating but with feature bagging and traverses each tree to generate multi-feature decision rules. This way, machine learning classification module efficiently explores a wide array of feature interactions. Exploring a wide array of feature interactions is useful to detect complex attack patterns while reducing the computational expenses.

Rule selection module 335 analyzes the decision rules generated by machine learning classification module 334 and determines an evadability score and a false positive score for each of the rules. The evadability is a metric which measures the ability of attackers to bypass the decision rule by modifying their tactics. Selecting attack features that have low evadability scores inhibits attackers retooling. The false positive score indicates how likely a decision rule will classify legitimate traffic sent by user systems 301 as attack traffic sent by bots 302. Rule selection module 335 discards rules that have evadability scores that exceed an evadability score threshold and discards rules that have false positive scores that exceed a false positive score threshold. Rule selection module 335 selects one or more of the remaining decision rules for security policy generation based on their evadability scores and false positive scores. Rule selection module 335 typically selects rules with lower evadability scores over rules with higher evadability scores. Rule selection module 335 typically selects rules with lower false positive scores over rules with high false positive scores. Policy generation module 336 forms security policies applicable by security proxy 321 based on the selected decision rules. Dashboard 337 may display the security policies generated by module 337 for review by operators. Operators may utilize dashboard 337 to adjust the evadability and false positive thresholds as well as the rule selection criteria used by rule selection module 335.

The computing systems of user systems 301, bots 302, gateway 310, API infrastructure 320, APIs 322-324, security proxy 321, resources 325, computing system 331, database 338, and dashboard 337 comprise components like processing systems and communication transceivers. The computing systems may include additional components like routers, user interfaces, data storage systems, power supplies, and the like. The computing systems may reside in a single device or may be distributed across multiple devices. The computing systems may be discrete systems or could be integrated within other systems, including other systems within system 300.

In some examples, communication network 300 implements process 200 illustrated in FIG. 2 and/or process 400 illustrated in FIG. 4. It should be appreciated that the structure and operation of communication network 300 may differ in other examples.

FIG. 4 illustrates process 400. Process 400 comprises an example operation of communication network 300 to utilize machine learning to detect and mitigate bot attacks. Process 400 comprises an example of process 200 illustrated in FIG. 2, however process 200 may differ. Process 400 may vary in other examples. In some examples, user systems 301 and bots 302 transfer traffic addressed for APIs 322-324 to access resources 325 to gateway 310. For example, the traffic may comprise API calls may comprise Hypertext Transfer Protocol Secure (HTTPS) messages. Gateway 310 routes the traffic to the respective ones of APIs 322-324 over security proxy 321. API calls 322-324 access resources 325 to generate response traffic and return the response traffic to user systems 301 and bots 302 over security proxy 321 and gateway 310. Security proxy 321 applies existing security policies to block unwanted request/response traffic and monitors for bot-attacks.

A malicious actor affiliated with bots 302 initiates an attack against API infrastructure 320. Bots 302 transfer malicious traffic (e.g., malformed API calls, API calls with invalid security credentials, API calls to access unauthorized resources, etc.) for APIs 322-324 over gateway 310 and security proxy 321 to attempt to drive APIs 322-324 to perform unauthorized or otherwise unwanted actions. Security proxy 321 detects the bot attack and notifies security platform 330. Security proxy 321 copies attack data that characterizes the traffic received by API infrastructure 320 after the attack is detected. In response to the attack alert, computing system 331 executes bot security pipeline 332.

Feature extraction module 333 obtains the attack data transferred security proxy 321 and obtains historical traffic data from database 338. The historical data characterizes traffic received over API infrastructure 320 during normal operating conditions (e.g., when a bot attack is not taking place). Feature extraction module 333 processes the received data (e.g., HTTPS requests, API calls, etc.) to determine features of the data. The features are date points that indicate distinguishing aspects of the attack and historical data. Exemplary features include the presence/absence, position, value, and/or other aspects of the request headers, request cookies, request body keys, query parameters, and the like. Other exemplary features include count-based features like the length and number of alphabetical characters, digits, and special characters that are included in some fields to capture the attackers' rotating value patterns which is a common evasion tactic in sophisticated attacks. Feature extraction module 333 prepares the extracted features for machine learning training. Data preparation includes a cleaning step to remove null and outlier features and a labeling step to indicate features that represent attack traffic and features that represent historical traffic. Feature extraction module 333 delivers the cleaned and labeled features to machine learning classification module 334.

Machine learning classification module 334 trains its machine learning algorithms using the labeled and cleaned features. The trained algorithms form a decision tree that classifies features of the attack traffic as either being associated with legitimate traffic (e.g., requests sent by user systems 301) or being associated with malicious traffic (e.g., requests sent as part of the bot attack by bots 302). Machine learning classification module 334 comprises operator configured settings that restrict the decision tree depth to facilitate simpler and more interpretable decision trees and to inhibit overfitting. Machine learning classification module 334 processes the decision tree to generate decision rules that identify features associated with malicious traffic transferred by bots 302 during the bot attack. Machine learning classification module 334 forms a set of decision rules based on single features (e.g., single branches of the decision tree). Machine learning classification module 334 forms a second set of decision rules based on combinations of the features (e.g., multiple branches of the decision tree). Machine learning classification module 334 provides the decision rules to rule selection module 335.

Rule selection module 335 determines the false positive rate and the evadability rate for each of the decision rules. For example, rule selection module 335 may determine the likelihood that legitimate traffic will trigger a decision rule to determine the false positive rate for that decision rule. For example, rule selection module 335 may determine how easy it is to bypass the conditions in a decision rule is to modify to determine the evadability score for that rule. Rule selection module 335 discards ones of the decision rules with threshold high false positive and/or evadability rates. Rule selection module 335 scores the remaining ones of the decision rules based on their evadability and false positive rate. For example, rule selection module 335 may calculate a weighted sum of the evadability rate and false positive rate for each decision rule and select the decision rule with the lowest weighted sum. Rule selection module 335 selects one or more of the decision rules based on their scores. Rule selection module 335 provides the selected decision rules to policy generation module 336. Policy generation module 336 generates security policies interpretable by security proxy 321. Policy generation module 336 loads the policies to security proxy 321 which enforces the policies to block traffic sent by bots 302 and to allow legitimate traffic.

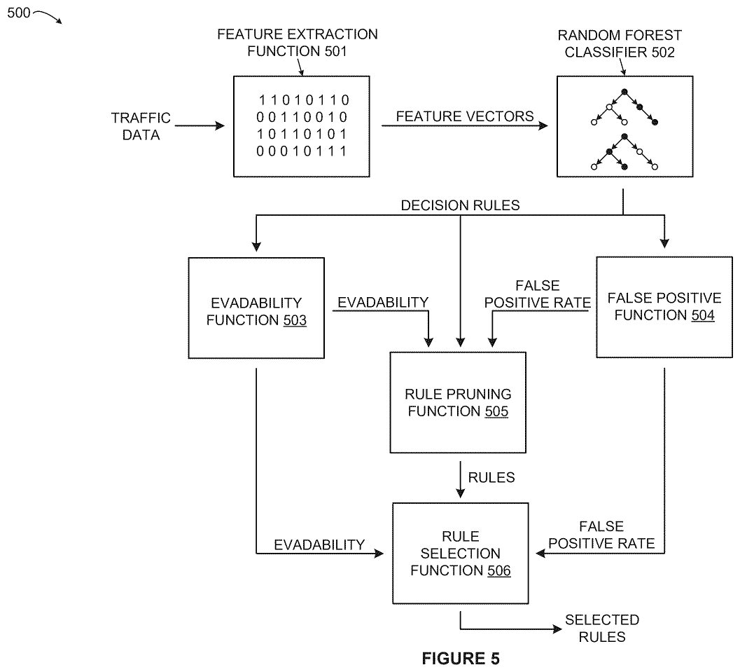

FIG. 5 illustrates machine learning bot detection system 500. Machine learning bot detection system 500 comprises an example of processing circuitry 320 illustrated in FIG. 1 and security platform 330 illustrated in FIG. 3, however processing circuitry 320 and security platform 330 may differ. Machine learning bot detection system 500 comprises feature extraction function 501, random forest classifier 502, evadability function 503, false positive function 504, rule pruning function 505, and rule selection function 506. Feature extraction function 501 receives traffic data (e.g., HTTP requests) sent during a bot attack and historical traffic data obtained during normal operating conditions. Feature extraction function 501 cleans the received data to remove outliers and null values. Feature extraction function 501 generates feature vectors that depict unique identifiers of the cleaned traffic data to form a training dataset for random forest classifier 502. A feature vector comprises a numeric data representation interpretable by a machine learning model. For example, function 301 may generate feature vectors that numerically represent request headers, request cookies, request body, query parameters, and/or other aspects of the traffic data.

Feature extraction function 501 provides the feature vectors to random forest classifier 502. Random forest classifier 502 ingests the feature vectors and trains its constituent machine learning algorithms to form decision trees that indicate aspects of the traffic data that are unique to the attack traffic. Random forest classifier 502 is trained without bootstrap aggregating but with feature bagging. Random forest classifier 502 traverses each decision tree to generate multi-feature decision rules. Computing false positive rate and recall for all possible two-feature combinations has a complexity of O(n²) with respect to the number of features. A traditional for-loop implementation is computationally intense, and a vectorized approach is impractical due to excessive memory demand. To address this, random forest classifier 502 is trained without bootstrap aggregating but with feature bagging. This means each decision tree in the forest is trained on the entire dataset, with a random selection of features at each split. This method results in a diverse set of decision trees, each contributing different two-feature rules. The number of trees, and thus the complexity of the model, is controlled by setting the number of estimators in random forest classifier 502. Each tree is then traversed to generate decision rules, and those that do not meet the thresholds for false positive rates and recall are pruned. This modification of random forest classifier 502 effectively addresses the computational and memory challenges of generating two-feature rules. By training each tree on the full dataset and incorporating feature bagging, the algorithm efficiently explores a wide array of feature interactions, which is useful when detecting complex attack patterns. Random forest classifier 502 also generates all one-feature rules based on the equality or inequality of a feature value, and metrics for each rule are computed by implementing a vectorized solution. This approach is more efficient than a traditional for-loop, which would have a complexity of O(n) with respect to the number of features. Random forest classifier 502 provides the resulting one-feature and multi-feature decision rules to evadability function 503, false positive function 504, and rule pruning function 505.

Evadability function 503 determines the evadability of each decision rule. Evadability is a metric which measures the ability of attackers to bypass the decision rule by modifying their tactics. Rules with lower evadability are preferred over rules with higher evadability. The evadability of a decision rule may depend on the feature type and the condition on that feature. From an attacker's perspective, evading a decision rule may comprise a two-step process. First, the attacker figures out the feature where the attacker is deviating from legitimate traffic. Second, the attacker figures out the condition on that feature that it needs to fix in order to bypass it. Consequently, the evadability of a decision rule may be defined by how hard it is for the attacker to identify the anomalous feature and how big the space (e.g., Degrees Of Freedom (DOF)) in which they can re-tool without any success, when trying to figure out how to bypass the condition. The greater the DOF, the longer it takes for the attacker to find the right condition. Evadability function 503 indicates the evadability for each decision rule to rule pruning function 505.

False positive function 504 determines the false-positive rate for each decision rule. The false positive rate indicates the likelihood the decision rule will incorrectly identify legitimate traffic as part of a bot attack. To compute the false positive rate and recall for each rule, a vectorized solution is implemented. This approach is more efficient than a traditional for-loop, which would have a complexity of O(n) with respect to the number of features. False positive function 505 delivers the false positive rate to rule pruning function 505 and to rule selection function 506.

After the rules are evaluated for false positive rate and evadability, rule pruning function 505 applies thresholds to discard rules with an evadability rate that exceeds an evadability threshold and/or rules with a false positive rate that exceeds a false positive threshold. The thresholds may be operator defined, preset, or selected using machine learning. Rule pruning function 505 combines multiple conditions on the same feature into a single condition and removes redundant conditions. Rule pruning function 505 also prunes redundant rules. Rule pruning function 505 provides pruned rules to rule selection function 506. Rule selection function 506 selects the rules that have lower evadability and lower false positive rate over rules that have higher evadability and higher false positive rate. For example, rule selection function 506 may host a data structure that receives evadability and false positive rate as inputs and algorithmically selects decision rules as outputs. The data structure may comprise a weighted sum function and/or some other type of scoring function. Rule selection function 506 provides the selected decision rules to downstream systems to generate security polices to block the bot attack. By blocking such attacks via machine learning automation, sophisticated attackers tend to retool and come back. The holistic approaches of looking at the whole HTTP request for attack features and selecting high fidelity features allows machine learning bot detection system 500 to stay ahead of the attacker.

Advantageously, machine learning bot detection system 500 automatically detects and mitigates sophisticated bot attacks with rapid response times. Machine learning bot detection system 500 drastically reduces the time and effort required from detecting an attack all the way to generating actionable policies that block the attack on customers on a day-to-day basis. Machine learning bot detection system 500 also considers the false positive rate and recall making sure there is no impact on legitimate users and also is able to tune these parameters based on the risk appetite of customers. This provides scalable solutions and is highly effective for a variety of customers regardless of the type of attack or business use case. On average the time taken for an analyst to identify the attack features can be an hour. With machine learning bot detection system 500, this reduces to just a few minutes. Additional benefits include having a clear idea of the impact on legitimate customers, which is not always possible in the case of manual analysis by an analyst. Machine learning bot detection system 500 is also highly adaptable when it sees the attacker changing tactics and returns after retooling. This ensures that machine learning bot detection system 500 keeps up with the evolving attack patterns and ensures mitigation with high efficacy.

The various embodiments described herein analyze the HTTP request as a whole and thus have an exhaustive set of features derived from the request. The various embodiments are capable of identifying complex patterns that accurately capture bot attacks, making it harder for attackers to bypass. The various embodiments look at each attack in an atomic way. The machine learning systems are invoked every time an attack is detected, and the model is trained on the fly. Because of this, the attack features identified are of high fidelity each time. Additionally, this solution generates interpretable and actionable rules and policies, along with associated metrics. This allows analysts to evaluate and act on the model's output with high confidence. Attacks sometimes comprise more than a million requests in a few minutes. The various embodiments may handle attack volumes of this scale and have also solved some engineering challenges to ensure effective model training as well as receiving insights quickly. An upper threshold on the number of records that are used to analyze for effective memory utilization in cases of high-volume attacks. If exceeded, records are sampled ensuring representative sampling and maintaining feature distribution. Some count-based features are derived to capture attackers' rotating value patterns, a common evasion tactic in sophisticated attacks.

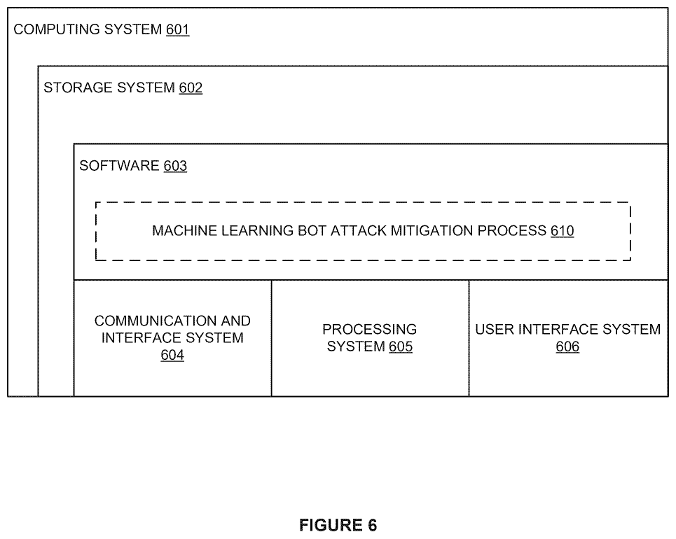

FIG. 6 illustrates computing device 601 which is representative of any system or collection of systems in which the various processes, programs, services, and scenarios disclosed herein to provide machine learning based bot attack mitigation. For example, computing device 601 may be representative of processing circuitry 320, security platform 330, machine learning bot detection system 500, and/or any other computing device contemplated herein. Examples of computing system 601 include, but are not limited to, server computers, routers, web servers, cloud computing platforms, and data center equipment, as well as any other type of physical or virtual server machine, physical or virtual router, container, and any variation or combination thereof.

Computing system 601 may be implemented as a single apparatus, system, or device or may be implemented in a distributed manner as multiple apparatuses, systems, or devices. Computing system 601 includes, but is not limited to, storage system 602, software 603, communication and interface system 604, processing system 605, and user interface system 606. Processing system 605 is operatively coupled with storage system 602, communication interface system 604, and user interface system 606.

Processing system 605 loads and executes software 603 from storage system 602. Software 603 includes and implements machine learning bot attack mitigation process 610, which is representative of the processes to provide to provide machine learning based bot attack mitigation as described in the preceding Figures. For example, machine learning bot attack detection process 610 may be representative of process 200 illustrated in FIG. 2, process 400 illustrated in FIG. 4, and/or any other machine learning based bot attack detection and mitigation process described herein. When executed by processing system 605, software 603 directs processing system 605 to operate as described herein for at least the various processes, operational scenarios, and sequences discussed in the foregoing implementations. Computing system 601 may optionally include additional devices, features, or functionality not discussed here for purposes of brevity.

Processing system 605 may comprise a micro-processor and other circuitry that retrieves and executes software 603 from storage system 602. Processing system 605 may be implemented within a single processing device but may also be distributed across multiple processing devices or sub-systems that cooperate in executing program instructions. Examples of processing system 605 include general purpose central processing units, graphical processing units, application specific processors, and logic devices, as well as any other type of processing device, combinations, or variations thereof.

Storage system 602 may comprise any computer readable storage media that is readable by processing system 605 and capable of storing software 603. Storage system 602 may include volatile and nonvolatile, removable, and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 602 may also include computer readable communication media over which at least some of software 603 may be communicated internally or externally. Storage system 602 may be implemented as a single storage device but may also be implemented across multiple storage devices or sub-systems co-located or distributed relative to each other. Storage system 602 may comprise additional elements, such as a controller capable of communicating with processing system 605 or possibly other systems.

Software 603 (including machine learning bot attack mitigation process 610) may be implemented in program instructions and among other functions may, when executed by processing system 605, direct processing system 605 to operate as described with respect to the various operational scenarios, sequences, and processes illustrated herein. For example, software 603 may include program instructions for extracting features from HTTP requests captured during a bot attack and features from HTTP requests captured during normal operating conditions and generate security polices based on features unique to the bot attack requests.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 603 may include additional processes, programs, or components, such as operating system software, virtualization software, or other application software. Software 603 may also comprise firmware or some other form of machine-readable processing instructions executable by processing system 605.

In general, software 603 may, when loaded into processing system 605 and executed, transform a suitable apparatus, system, or device (of which computing system 601 is representative) overall from a general-purpose computing system into a special-purpose computing system customized to provide machine learning based bot attack mitigation as described herein. Indeed, encoding software 603 on storage system 602 may transform the physical structure of storage system 602. The specific transformation of the physical structure may depend on various factors in different implementations of this description. Examples of such factors may include, but are not limited to, the technology used to implement the storage media of storage system 602 and whether the computer-storage media are characterized as primary or secondary storage, as well as other factors.

For example, if the computer readable storage media are implemented as semiconductor-based memory, software 603 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 604 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 601 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

While some examples provided herein are described in the context of computing devices to provide machine learning based bot attack mitigation, it should be understood that the systems and methods described herein are not limited to such embodiments and may apply to a variety of other extension implementation environments and their associated systems. As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A method comprising:
in response to an attack notification, obtaining historical traffic data and attack traffic data, wherein the attack traffic data characterizes traffic received during a bot attack and the historical traffic data characterizes other traffic received when the bot attack is not occurring;
extracting features from the historical traffic data and the attack traffic data;
training a machine learning classifier to identify ones of the features that correspond to attack traffic and ones of the features that correspond to legitimate traffic;
forming decision rules based on an output from the machine learning classifier to block the attack traffic based on the ones of the features that correspond to the attack traffic; and
generating one or more security policies based on the decision rules.

2. The method of claim 1 further comprising:
determining a false positive rate and an evadability score for each of the decision rules;
comparing the false positive rate for each of the decision rules to a false positive threshold;
comparing the evadability score for each of the decision rules to an evadability threshold;
discarding ones of the decision rules that exceed the false positive threshold or the evadability threshold; and
selecting one or more remaining decision rules based on the false positive rate and the evadability score for each of the remaining decision rules; and wherein:
generating the one or more security policies based on the decision rules comprises generating the one or more security policies based on the one or more selected decision rules.

3. The method of claim 2 further comprising generating a score for each of the one or more remaining decision rules based on the false positive rate and the evadability score; and wherein:
selecting the one or more remaining decision rules based on the false positive rate and the evadability score for each of the remaining decision rules comprises selecting the one or more remaining decision rules based on the score for each of the one or more remaining decision rules.

4. The method of claim 1 further comprising:
cleaning the features to remove null features and outlier features;
labeling the cleaned features to indicate ones of the cleaned features that represent the attack traffic data and ones of the cleaned features that represent the historical traffic data; and
providing the labeled and cleaned features to the machine learning classifier.

5. The method of claim 1 wherein training the machine learning classifier to identify the ones of the features that correspond to the attack traffic and the ones of the features that correspond to the legitimate traffic comprises generating a decision tree that classifies the features extracted from the attack traffic data as being either associated with the attack traffic or with the legitimate traffic.

6. The method of claim 5 wherein generating the decision tree comprises applying an operator configured setting that limits a depth of the decision tree.

7. The method of claim 1 further comprising loading the one or more security policies to a security proxy to block the attack traffic.

8. The method of claim 1 wherein the features comprise data that characterizes one or more of a request header, a request cookie, a request body key, a query parameter, an alphabetical character, a digit, or a special character included in the historical traffic data and attack traffic data.

9. The method of claim 1 wherein the attack traffic comprises one or more of Application Programming Interface (API) calls or Hypertext Transport Protocol (HTTP) requests and the legitimate traffic comprises one or more of historic API calls or historic HTTP requests.

10. The method of claim 1 wherein the machine learning classifier comprises a random forest classifier.

11. A system comprising:
processing circuitry configured to:
in response to an attack notification, obtain historical traffic data and attack traffic data, wherein the attack traffic data characterizes traffic received during a bot attack and the historical traffic data characterizes other traffic received when the bot attack is not occurring;
extract features from the historical traffic data and the attack traffic data;
train a machine learning classifier to identify ones of the features that correspond to attack traffic and ones of the features that correspond to legitimate traffic;
form decision rules based on an output from the machine learning classifier to block the attack traffic based on the ones of the features that correspond to the attack traffic; and
generate one or more security policies based on the decision rules.

12. The system of claim 11 wherein the processing circuitry is further configured to:
determine a false positive rate and an evadability score for each of the decision rules;
compare the false positive rate for each of the decision rules to a false positive threshold;
compare the evadability score for each of the decision rules to an evadability threshold;
discard ones of the decision rules that exceed the false positive threshold or the evadability threshold; and
select one or more remaining decision rules based on the false positive rate and the evadability score for each of the remaining decision rules; and wherein the processing circuitry is configured to:
generate the one or more security policies based on the one or more selected decision rules to generate the one or more security policies based on the decision rules.

13. The system of claim 12 wherein the processing circuitry is further configured to:
generate a score for each of the one or more remaining decision rules based on the false positive rate and the evadability score; and wherein the processing circuitry is configured to:
select the one or more remaining decision rules based on the score for each of the one or more remaining decision rules to select the one or more remaining decision rules based on the false positive rate and the evadability score for each of the remaining decision rules.

14. The system of claim 11 wherein the processing circuitry is further configured to:
clean the features to remove null features and outlier features;
label the cleaned features to indicate ones of the cleaned features that represent the attack traffic data and ones of the cleaned features that represent the historical traffic data; and
provide the labeled and cleaned features to the machine learning classifier.

15. The system of claim 11 wherein the processing circuitry is configured to generate a decision tree that classifies the features extracted from the attack traffic data as being either associated with the attack traffic or with the legitimate traffic to train the machine learning classifier to identify the ones of the features that correspond to the attack traffic and the ones of the features that correspond to the legitimate traffic.

16. The system of claim 15 wherein the processing circuitry is configured to apply an operator configured setting that limits a depth of the decision tree to generate the decision tree.

17. The system of claim 11 wherein the processing circuitry is further configured to load the one or more security policies to a security proxy to block the attack traffic.

18. The system of claim 11 wherein:
the attack traffic comprises one or more of Application Programming Interface (API) calls or Hypertext Transport Protocol (HTTP) requests and the legitimate traffic comprises one or more of historic API calls or historic HTTP requests; and
the features comprise data that characterizes one or more of a request header, a request cookie, a request body key, a query parameter, an alphabetical character, a digit, or a special character included in the API calls and the historic API calls.

19. The system of claim 11 wherein the machine learning classifier comprises a random forest classifier.

20. One or more computer-readable storage media having program instructions stored thereon, wherein the program instructions, when executed by a computing system, direct the computing system to perform operations, the operations comprising:
in response to an attack notification, obtaining historical traffic data and attack traffic data, wherein the attack traffic data characterizes traffic received during a bot attack and the historical traffic data characterizes other traffic received when the bot attack is not occurring;
extracting features from the historical traffic data and the attack traffic data;
training a machine learning classifier to identify ones of the features that correspond to attack traffic and ones of the features that correspond to legitimate traffic;
forming decision rules based on an output from the machine learning classifier to block the attack traffic based on the ones of the features that correspond to the attack traffic; and
generating one or more security policies based on the decision rules.
